(19) United States
(12) Patent Application Publication
(10) Pub. No.: US 2016/0266274 A1
(43) Pub. Date: Sep. 15, 2016

(54) IDENTIFYING SWEET SPOTS IN UNCONVENTIONAL HYDROCARBON RESERVOIRS

(71) Applicant: SAUDI ARABIAN OIL COMPANY, Dhahran (SA)

(72) Inventors: Mohammad H. Alqam, Dhahran (SA); Hameed H. Badairy, Dhahran (SA)

(21) Appl. No.: 14/656,480

(22) Filed: Mar. 12, 2015

(51) Int. Cl. G01V 5/08

(52) U.S. Cl. CPC G01V 5/085

(57) ABSTRACT

Techniques for identifying sweet spots in unconventional hydrocarbon reservoirs are described. A rock sample is obtained from an unconventional hydrocarbon reservoir. The rock sample is evaluated using multiple rock sample evaluation techniques. A Young's modulus and a Poisson's ratio are determined for the rock sample. Geo-mechanical properties of the rock sample are determined based on results of evaluating the rock sample using the multiple rock sample evaluation techniques, the Young's modulus and the Poisson's ratio. One or more sweet spots for production in the unconventional hydrocarbon reservoir are identified based, in part, on the geo-mechanical properties of the rock sample

### TECHNICAL FIELD

This disclosure relates to hydrocarbon reservoirs, for example, reservoirs from which hydrocarbons can be retrieved.

### BACKGROUND

Shale gas refers to hydrocarbons, for example, natural gas, which is trapped within hydrocarbon reservoirs, for example, shale formations or shale gas reservoirs. In a shale gas reservoir, the organic-rich shale can be both the source and reservoir rock. Shale gas potential is not confined to limited traps or structures, as, for example, in conventional gas production, but may be distributed across large geographic areas. Shales are fine-grained sedimentary rocks that can be rich sources of hydrocarbons, for example, petroleum, natural gas, or other hydrocarbons. Shales have a complex distribution of minerals including several major and trace elements, for example, quartz, feldspar, carbonate, clay minerals, iron oxides, and other minerals.

### SUMMARY

This disclosure relates to identifying sweet spots in unconventional hydrocarbon reservoirs.

Some implementations of the subject matter described here can be implemented as a method. A rock sample is obtained from an unconventional hydrocarbon reservoir. The rock sample is evaluated using multiple rock sample evaluation techniques. A Young's modulus and a Poisson's ratio are determined for the rock sample. Geo-mechanical properties of the rock sample are determined based on results of evaluating the rock sample using the multiple rock sample evaluation techniques, the Young's modulus and the Poisson's ratio. One or more sweet spots for production in the unconventional hydrocarbon reservoir are identified based, in part, on the geo-mechanical properties of the rock sample.

This, and other aspects, can include one or more of the following features. The multiple rock sample evaluation techniques can include scanning electron microscopy. Evaluating the rock sample using scanning electron microscopy can include evaluating the rock sample using an environmental scanning electron microscope (ESEM) with integrated energy dispersive X-ray micro-analysis system (EDS). The ESEM can be operated at 15 kV (kilo volt), 0.15 Torr water vapor pressure and about 10 mm (millimeter) working distance. The results of evaluating the rock sample using the ESEM can include surface images from the rock sample. The geo-mechanical properties of the rock sample can include textural information about the rock sample determined based on the surface images. The multiple rock sample evaluation techniques can include X-ray diffraction. To evaluate the rock sample using X-ray diffraction, a power can be formed from at least a portion of the rock sample. The power can include fractions of the crushed rock sample. The powder can be separated and dried in air. The air dried powder can be glycolated in a dessicator including ethylene glycol at 60° C. (centigrade). To form the powder, at least the portion of the rock sample can be crushed in a mortar and pestle. The crushed rock sample can be transferred into a pre-weighted glass centrifuge tube. A quantity of dispersing agent can be added to the centrifuge tube. The tube can be filled with water. The tube can be sonicated to disperse at least the portion of the rock sample into clay size fractions. The centrifuge tube can be centrifuged to separate contents of the tube into a top portion including the clay size fraction. Some of the clay size fraction can be transferred to a different centrifuge tube. Hydrochloric acid can be added to the centrifuge tube. Clay size fraction in the centrifuge tube can be allowed to settle. Water can be removed from the centrifuge tube. Calcium fluoride can be added to the centrifuge tube. The geo-mechanical properties of the rock sample based on the Young's modulus and Poisson's ratio can include at least one of facies identifications, mineral content, or rock strength. A velocity of compressional waves (Vₚ) and velocity of shear waves (Vₛ) for the rock sample can be determined using the Young's modulus and the Poisson's ratio for the rock sample. A ratio of Vₚ to Vₛ can be determined for the rock sample. The geo-mechanical properties of the rock sample can include rock porosity, reservoir fluid type and lithography determined based, in part, on the ratio. Multiple rock samples can be obtained from different locations in the unconventional hydrocarbon reservoir. Each rock sample can be evaluated using the multiple rock sample evaluation techniques. A respective Young's modulus and a respective Poisson's ratio can be determined for each rock sample. Geo-mechanical properties of each rock sample can be determined based on results of evaluating each rock sample using the multiple rock sample evaluation techniques, each Young's modulus and each Poisson's ratio. Multiple sweet spots can be identified including the one or more sweet spots for production in the unconventional hydrocarbon reservoir based, in part, on the geo-mechanical properties of each rock sample. The unconventional hydrocarbon reservoir can be a shale gas reservoir.

The details of one or more implementations of the subject matter described in this specification are set forth in the accompanying drawings and the description that follows. Other features, aspects, and advantages of the subject matter will become apparent from the description, the drawings, and the claims.

### BRIEF DESCRIPTION OF THE DRAWINGS

FIGS. 1A and 1B show examples of rock samples obtained from an unconventional hydrocarbon reservoir.

FIG. 2 shows a table of rock mechanical properties of example rock samples.

FIG. 3 shows an example plot of stress versus strain curves associated with multiple rock samples.

FIG. 4 shows a table of porosity and permeability values measured for rock samples.

FIGS. 5A-5D show examples of X-Ray diffraction analysis performed on rock samples.

FIGS. 6A-6F show example backscattered electron images and corresponding EDS X-Ray spectra for a rock sample.

FIG. 7 is a flowchart of an example process for identifying sweet spots in an unconventional hydrocarbon reservoir.

### DETAILED DESCRIPTION

This disclosure describes identifying sweet spots in unconventional hydrocarbon reservoirs, for example, shale gas reservoirs. A sweet spot refers to target locations or areas in unconventional hydrocarbon reservoirs that have a high potential for production. Shale gas reservoirs, and particularly the sweet spots in shale gas reservoirs, contain high levels of trapped hydrocarbons, for example, gas, which can be difficult or costly to extract (or both). Geo-mechanical properties of rock in the shale gas reservoir can serve as an indicator for the amount of hydrocarbons trapped in the locations from which the rock was retrieved. For example, the porosity level of the rock indicates a potential amount of hydrocarbon-in-place while the mineral composition of the rock indicates hydro-fracture generation and propagation. Geo-mechanical properties also indicate the feasibility of hydraulic fracturing in the locations from which the rock was retrieved. The geo-chemical properties of the rocks retrieved from different locations of the shale gas reservoir enable determining a mineralogy of the shale gas reservoir.

As described in the following paragraphs, the mineralogy of a shale gas reservoir is used to infer chemical and physical properties of the shale. For example, high quartz or carbonate content indicate that the shale is brittle and more amenable to hydraulic fracturing treatment compared to other, relatively less brittle regions of the shale gas reservoir. The characterization of the shale gas reservoir based, in part, on mineralogy can be coupled with the understanding of the elastic response of rocks to establish an experimental basis for identifying velocity variations due to different lithology, fluid type and fluid pressure changes. Sweet spots that can maximize production can be identified by coupling the micro-structural characterization and elastic properties. Also, locations in the shale gas reservoir with best production potential can be predicted for drilling. In addition, areas of high total organic content (TOC), which will fracture easily to form good flow networks can also be identified. In this manner, the detailed geo-mechanical and lithological characterization process of the shale samples can maximize the return on drilling investment. The knowledge gained by studying the role of rock mechanics, stress-dependent permeability and characterization study of tight gas/shale formations can be used to develop in-house know-how and skills to enable setting guidelines for evaluating and designing best practices to produce from shale gas reservoirs. In addition, implementing the techniques described here can allow evolving engineering and evaluation approaches as a practical and acceptable production opportunity due to the complex nature of tight sand and shale gas. The knowledge, expertise and technologies that have been implemented in production zones in one part of the world, for example, United States of America, Canada, and that have been implemented to address technology gaps caused by unique reservoir and well environments can be applied effectively and efficiently in production zones in another part of the world, for example, in the Middle East.

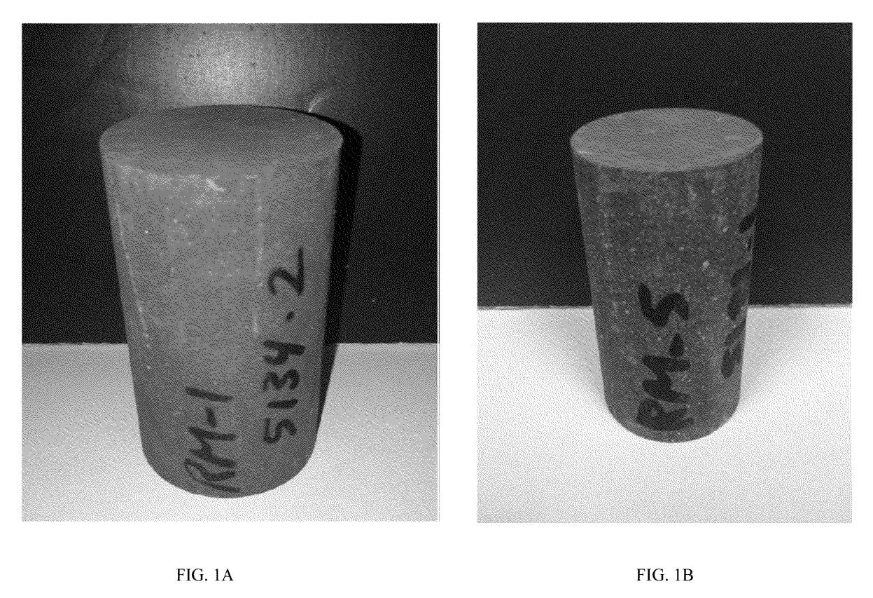

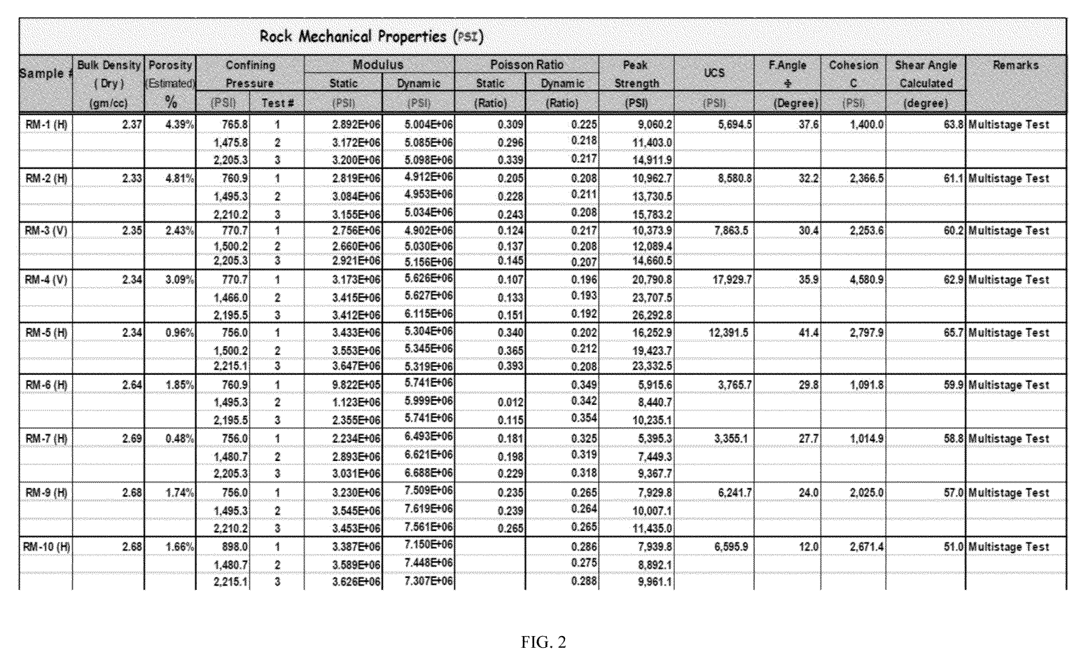

FIGS. 1A and 1B show examples of rock samples obtained from an unconventional hydrocarbon reservoir. Representative rock samples were selected from different locations (for example, from different depths or other locations) of an unconventional hydrocarbon reservoir, for example, a shale gas reservoir. As described in the following paragraphs, the rock mechanical properties were studied using multiple rock sample evaluation techniques, for example, microscopy, spectroscopy, and other techniques. FIG. 2 shows a table of rock mechanical properties of example rock samples.

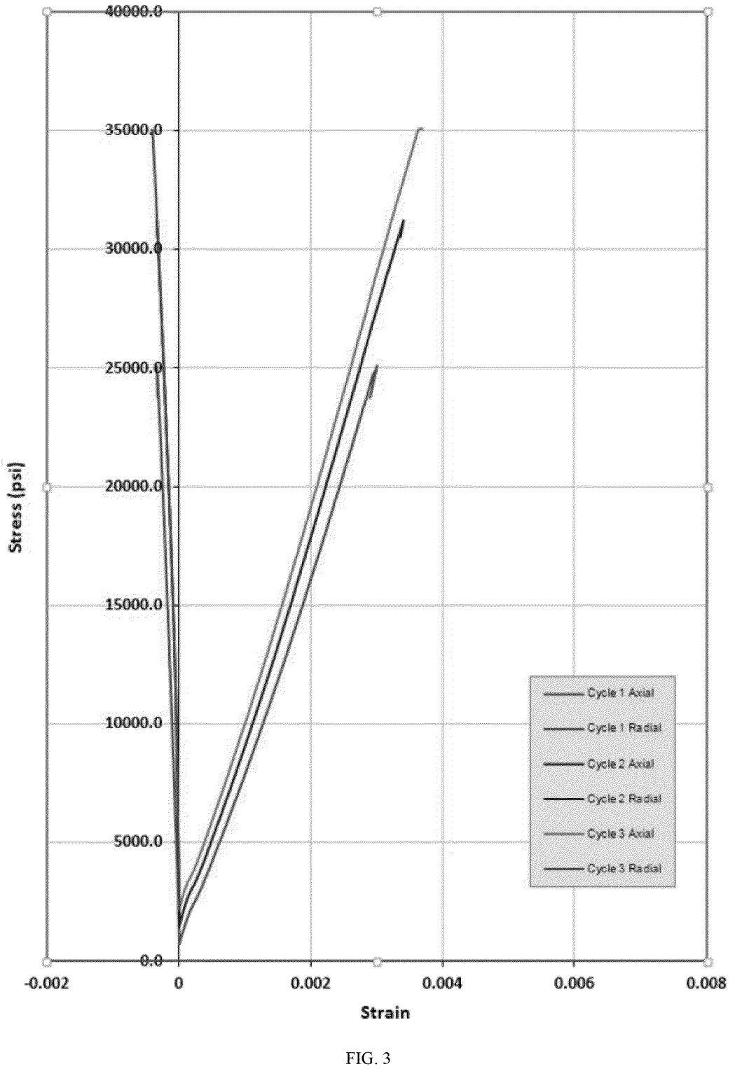

FIG. 3 shows an example plot of stress versus strain curves associated with multiple rock samples. In some implementations, ultrasonic compressional and shear velocities were measured on each sample and dynamic Young's modulus and Poisson's ratio were obtained for each sample. For each rock sample, a velocity of compressional waves (Vₚ) and velocity of shear waves (Vₛ) can be determined using the Young's modulus and Poisson's ratio. The elastic response of the rock samples can establish an experimental basis for identifying velocities variations due to different lithology, fluid type and fluid pressure changes. For example, fluid effects on Vₚ/Vₛ are significant but less than lithology effects. Also, a ratio of Vₚ/Vₛ changes due to primary depletion (pore pressure decreases) and are difficult to observe in un-fractured tight gas sandstones. However, Vₚ/Vₛ is very sensitive to pore pressure increases and could be used as an overpressure indicator. Tight gas sandstones will typically have a Vₚ/Vₛ lower than 1.7, while shales will have Vₚ/Vₛ higher than 1.7. Thus, a decrease in Vₚ/Vₛ can be expected from shales to sandstone streaks. Typically, the presence of gas-saturated sandstones in sandstone streaks will lower the Vₚ/Vₛ even further (Vₚ/Vₛ of 1.6 or lower) and overpressure conditions can lower Vₚ/Vₛ even more (<1.5). In this manner, the Young's modulus and Poisson's ratio for each rock sample can enable determining geo-mechanical properties of the rock sample and of the unconventional hydrocarbon reservoir from which the rock sample was obtained.

In some implementations, porosity determination of each rock sample was one of the multiple rock sample evaluations performed on each rock sample. Porosity is defined as the volume of void space divided by the volume of the rock and is a good indicator of the volume of hydrocarbons potentially contained in a rock. An example of measuring pore volume is described here. Before the pore volume of samples is conducted, the dead volume (V_{Dead}) of the equipment and the external plumbing system was measured and recorded. Helium at a known reference pressure (P₁) and volume (V_{Ref}) was isothermally expanded into the sample's pore space (V_{Pore}) and after stabilization, the pressure (P2) was recorded. Then, ore, porosity was reported as a percentage of bulk volume.

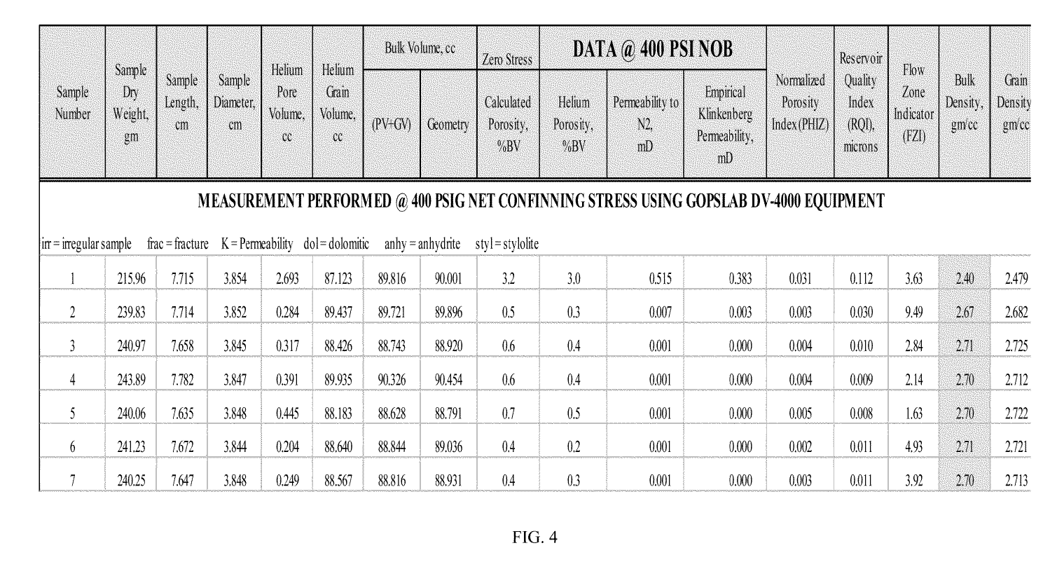

In some implementations, permeability determination of each rock sample was one of the multiple rock sample evaluations performed on each rock sample. Permeability is defined as the ability of the formation to transmit fluids (liquid or gas) under the effect of a pressure gradient and provides information as to the mobility of the fluids. In some implementations, a system that implements a complex transient technique can be used to make measurements on rock samples over a wide range of permeability. To do so, the system can be configured to control the pore pressure at one end of the rock sample (the “upstream end”) while the other end (the “downstream end”) is attached to a fixed volume filled with pore fluid. The pressure can be monitored at both the upstream and downstream ends of the rock sample. Starting with the system in equilibrium, the pressure at the upstream end of the sample can be perturbed and the response at the downstream end of the sample can be measured. The responses at the downstream end to the perturbation of pressure at the upstream end can provide a measure of permeability of the rock sample. FIG. 4 shows a table of porosity and permeability values measured for rock samples.

In some implementations, scanning electron microscopy (SEM) and X-Ray diffraction are two rock sample evaluations techniques implemented on each rock sample to perform morphological characterization of each rock sample. For example, a portion of a rock sample was examined using an environmental scanning electron microscope (ESEM) with integrated energy dispersive X-ray micro-analysis system (EDS). The rock samples were mounted on ESEM holders, for example, using double-sided carbon tape, and then inserted into the microscope chamber for analysis. The microscope was operated at 15 kV, 0.5 Torr water vapor pressure and around 10 mm working distance to obtain surface images of the rock samples. Geo-mechanical properties such as textural information about the rock samples was obtained from the surface images. X-ray diffraction (XRD) and Scanning Electron Microscopy (SEM) have been used to understand composition and texture, organic maturity and shale diagenesis, and their impact on reservoir properties. Therefore, coupling these techniques with geo-mechanics can provide geo-steering techniques to target these zones during the hydraulic fracturing of these formations. The integration of the two techniques can be implemented as a tool for the identification of sweet spots using the geo-mechanical data to assist in the design of hydraulic fracturing treatments.

For X-Ray diffraction analysis, all or a portion of each rock sample was processed using the clay size fraction separation technique. In some implementations, all or a portion of each rock sample was separated by sedimentation technique. To do so, a quantity, for example, approximately 3 g (gram) or a different quantity, of the sample was gently crushed, for example, using a mortar and pestle, and transferred to a pre-weighed glass centrifuge tube. A volume, for example, approximately 3 mL (milliliter) or a different volume, of a dispersing agent, for example, sodium hexa-meta phosphate or other dispersing agent, was added to the centrifuge tube. The tube was filled with water and sonicated, for example, in a sonifer, to disperse clay size fractions. The centrifuge tube was placed into a centrifuge jar and centrifuged for a duration, for example, approximately 5 minutes or a different duration. The top portion of the centrifuge tube containing clay size fraction was transferred into a plastic centrifuge tube. A volume, for example, two or three drops or different volume, of 15% hydrochloric acid (HCl) was added to the plastic centrifuge tube for a duration, for example, approximately five minutes or different duration. The mixture was left until the clay fractions settled down. Then, the water was removed. A quantity of calcium fluoride was added to the samples for two-theta displacement corrections. The slurry was poured onto a glass slide and then left overnight to dry. The air-dried glass slide was dried, for example, glycolated, in a desiccator containing ethylene glycol at 60° C. in an oven.

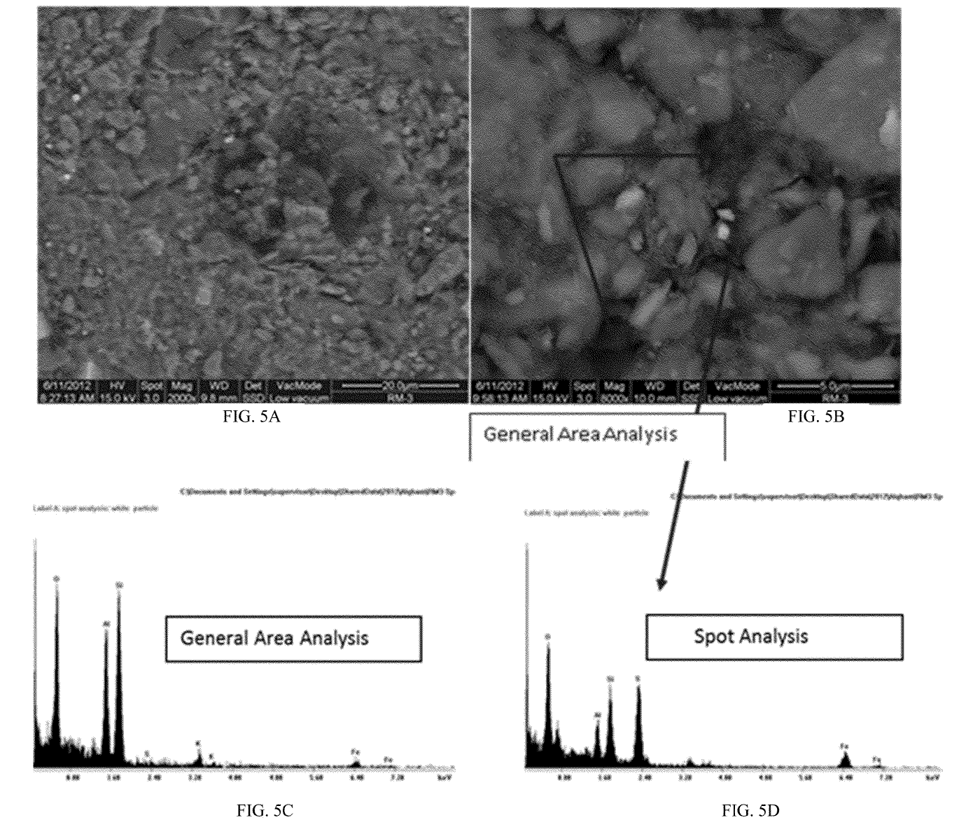

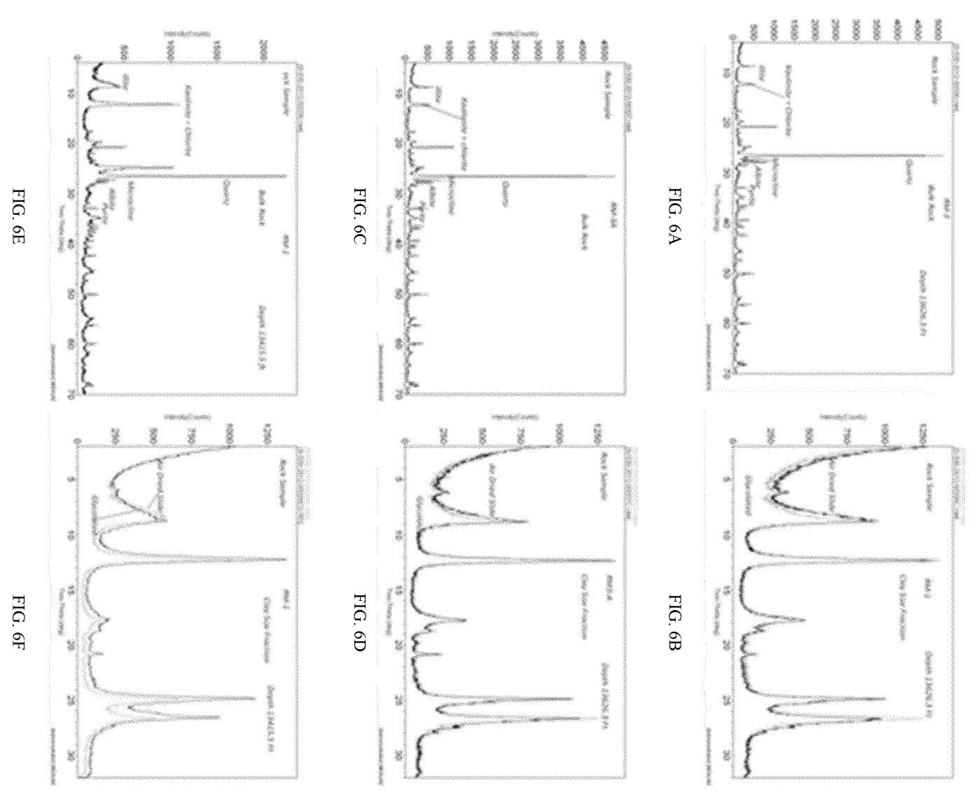

FIGS. 5A-5D show examples of X-Ray diffraction analysis performed on rock samples. FIGS. 6A-6F show example backscattered electron images and corresponding EDS X-Ray spectra for a rock sample. The SEM images of a rock sample show the presence of nanoscale pores and micro-cracks in rock samples. A general analysis of energy dispersive X-Ray for the rock sample reveals that the formation is composed of oxygen, silicon and aluminum as major elements with measurable amounts of potassium, sulfur and iron. A spot analysis of energy dispersive X-Ray for the rock sample reveals the presence of white particles rich in iron. For example, for the rock sample taken from a depth of 13,415.5 ft, iron-sulfur rich particles were prominent. The results of the X-Ray diffraction bulk analyses were in agreement with the ESEM data for the same rock sample. Both showed that the rock sample included silicon, aluminum and oxygen-rich compounds.

As described earlier, the clay-sized particles (for example, approximately less than 2 μm (micrometer) equivalent spherical diameter) were separated from the larger sized particles by sedimentation techniques. The compounds present in air-dried slides were identified by their highest peak positions. The bulk rock analysis results for three rock samples are shown in the following table.

TABLE 1
X-Ray diffraction data for three rock samples.

| | | Approximate Weigh Percentages | | | | | | | | | |
|---|---|---|---|---|---|---|---|---|---|---|---|
| | Depth | Clay Minerals | | | | Other Minerals | | | | | |
| Sample | (ft) | K | I | IS | Cl | Q | M | Al | P | % S in I-S | F |
| RM3 | 13626.5 | 13.0 | 8.8 | 2.2 | 4.7 | 49.3 | 6.1 | 10.5 | 5.4 | 10-12 | 1 |
| RM3A | 13626.5 | 14.7 | 9.3 | 3.0 | 5.0 | 48.3 | 4.5 | 7.2 | 7.9 | 10-12 | 2 |
| RM1 | 13415.5 | 30.2 | 17.1 | 13.8 | 10.7 | 20.5 | 2.8 | 2.4 | 2.5 | 14-20 | 3 |

In Table 1, K is kaolinite, I is illite, I-S is illite-smectite, Cl is chlorite, Q is quartz, M is microcline, Al is Albite, and P is Pyrite. The results shown in Table 1 are calibrated and verified clay analysis results. The dried slides were re-analyzed by X-Ray diffraction and the results compared with air-dried slides. The results showed the presence of mixed layer of illite-smectite. The level of kaolinite for a first rock sample (RM1) appeared to be one magnitude higher than that in the case of the two other rock samples (RM3 and RM3A). Also, the level of illite-smectite clay in the first rock sample (RM1) was found to be four times higher than that in the case of the other two rock samples (RM3 and RM3A).

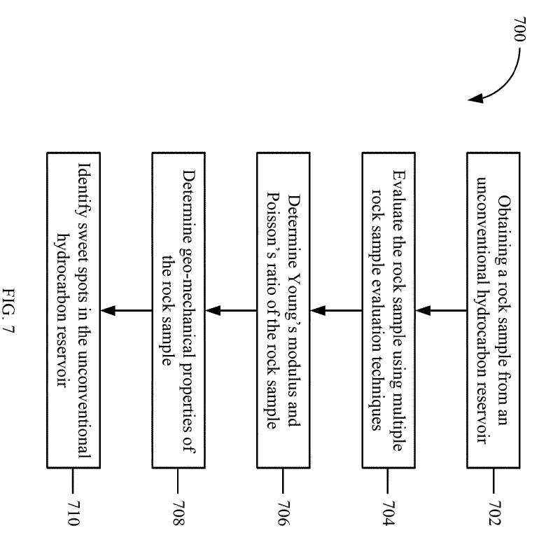

FIG. 7 is a flowchart of an example process 700 for identifying sweet spots in an unconventional hydrocarbon reservoir. At 702, a rock sample is obtained from an unconventional hydrocarbon reservoir, for example, a shale gas reservoir. At 704, the rock sample is evaluated using multiple rock sample evaluation techniques, for example, SEM, X-Ray diffraction, porosity evaluation, permeability evaluation, or other rock sample evaluation techniques (or combinations of them). At 706, a Young's modulus and a Poisson's ratio for the rock sample is determined. At 708, geo-mechanical properties of the rock sample are determined based on the results of evaluating the rock sample using the multiple rock sample evaluation techniques, the Young's modulus and the Poisson's ratio. At 710, one or more sweet spots are identified for production in the unconventional hydrocarbon reservoir based, in part, on the geo-mechanical properties of the rock sample.

For example, tight gas sandstones will have a Vₚ/Vₛ lower than 1.7, while shales will have Vₚ/Vₛ higher than 1.7. Consequently, a lower Vₚ/Vₛ can indicate sandstone streaks while a higher Vₚ/Vₛ can indicate shales. In another example, the presence of gas-saturated sandstones in sandstone streaks can further lower Vₚ/Vₛ (for example, 1.6 or lower). Overpressure conditions can lower Vₚ/Vₛ even further (for example, lower than 1.5). Therefore, a measure of Vₚ/Vₛ can be used to identify sweet spots.

In sum, the techniques described in this disclosure involve using scanning electron microscopy and energy dispersive X-ray microanalysis techniques to characterize shale gas rocks in term of morphology, micro-fractures and pores identification and chemical compositional. Ultrasonic compressional and shear velocities were measured on each sample and dynamic Young's modulus and Poisson's ratio were obtained. Geo-mechanical properties of shale were determined using the results of these analyses on the rock samples. Shale plays have complex mineralogy containing many major and trace elements. Various minerals have been evaluated during x-ray analysis study. These minerals are mainly: quartz, feldspar, carbonate, clay minerals, and iron oxide. The presence of certain minerals can indicate the chemical and physical properties of these plays. For example, the presence of high quartz or carbonate minerals in this formation can add more brittleness to the formation and make it more susceptible to hydraulic fracturing. In this manner, the coupling of both microstructural characterization and elastic properties can provide a procedure to identify the sweet spots plays and maximize gas production.

Thus, particular implementations of the subject matter have been described. Other implementations are within the scope of the following claims.

1. A method comprising:
obtaining a rock sample from an unconventional hydrocarbon reservoir;
evaluating the rock sample using a plurality of rock sample evaluation techniques;
determining a Young's modulus and a Poisson's ratio for the rock sample;
determining geo-mechanical properties of the rock sample based on results of evaluating the rock sample using the plurality of rock sample evaluation techniques, the Young's modulus and the Poisson's ratio; and
identifying one or more sweet spots for production in the unconventional hydrocarbon reservoir based, in part, on the geo-mechanical properties of the rock sample.

2. The method of claim 1, wherein the plurality of rock sample evaluation techniques comprises scanning electron microscopy.

3. The method of claim 1, wherein evaluating the rock sample using scanning electron microscopy comprises evaluating the rock sample using an environmental scanning electron microscope (ESEM) with integrated energy dispersive X-ray micro-analysis system (EDS).

4. The method of claim 3, further comprising operating the ESEM at 15 kV, 0.15 Torr water vapor pressure and about 10 mm working distance.

5. The method of claim 3, wherein the results of evaluating the rock sample using the ESEM comprises surface images from the rock sample.

6. The method of claim 5, wherein the geo-mechanical properties of the rock sample comprise textural information about the rock sample determined based on the surface images.

7. The method of claim 1, wherein the plurality of rock sample evaluation techniques comprises X-ray diffraction.

8. The method of claim 7, wherein evaluating the rock sample using X-ray diffraction comprises:
forming a powder from at least a portion of the rock sample, the powder comprising fractions of the crushed rock sample;
separating and drying the powder in air; and
drying the air dried powder in a desiccator including ethylene glycol at 60° C.

9. The method of claim 8, wherein forming the powder comprises:
crushing at least the portion of the rock sample in a mortar and pestle;
transferring the crushed rock sample into a pre-weighed glass centrifuge tube;
adding a quantity of dispersing agent to the centrifuge tube;
filling the tube with water;
sonicating the tube to disperse at least the portion of the rock sample into clay size fractions;
centrifuging the centrifuge tube, the centrifuging separating contents of the tube into a top portion including the clay size fraction;
transferring some of the clay size fraction to a different centrifuge tube;
adding hydrochloric acid to the centrifuge tube;
allowing clay size fraction in the centrifuge tube to settle;
removing water from the centrifuge tube; and
adding calcium fluoride to the centrifuge tube.

10. The method of claim 1, wherein the geo-mechanical properties of the rock sample based on the Young's modulus and Poisson's ratio comprise at least one of facies identifications, mineral content, or rock strength.

11. The method of claim 1, further comprising determining a velocity of compressional waves (Vₚ) and velocity of shear waves (Vₛ) for the rock sample using the Young's modulus and the Poisson's ratio for the rock sample.

12. The method of claim 11, further comprising determining a ratio of Vₚ to Vₛ for the rock sample, wherein the geo-mechanical properties of the rock sample comprises rock porosity, reservoir fluid type and lithography determined based, in part, on the ratio.

13. The method of claim 1, further comprising:
obtaining a plurality of rock samples from different locations in the unconventional hydrocarbon reservoir;
evaluating each rock sample using the plurality of rock sample evaluation techniques;
determining a respective Young's modulus and a respective Poisson's ratio for each rock sample;
determining geo-mechanical properties of each rock sample based on results of evaluating each rock sample using the plurality of rock sample evaluation techniques, each Young's modulus and each Poisson's ratio; and
identifying a plurality of sweet spots, including the one or more sweet spots, for production in the unconventional hydrocarbon reservoir based, in part, on the geo-mechanical properties of each rock sample.

14. The method of claim 1, wherein the unconventional hydrocarbon reservoir is a shale gas reservoir.
